(19) United States
(12) Patent Application Publication
(10) Pub. No.: US 2024/0347034 A1
(43) Pub. Date: Oct. 17, 2024

(54) METHOD AND APPARATUS FOR DISCERNING SOUND REACHING THROUGH A BARRIER

(71) Applicant: Alango Technologies, Tirat Carmel (IL)

(72) Inventor: Alexander Goldin, Haifa (IL)

(21) Appl. No.: 18/633,252

(22) Filed: Apr. 11, 2024

Related U.S. Application Data
(60) Provisional application No. 63/495,303, filed on Apr. 11, 2023.

(51) Int. Cl. G10K 11/178

(52) U.S. Cl. CPC G10K 11/17854; G10K 11/17881; G10K 2210/1282

(57) ABSTRACT

The invention provides a method and an apparatus for discerning sound produced outside a barrier to a listener located on its other side. The method includes sensing vibrations of the barrier by a vibration sensor (VS), sensing the sound on the internal side of the barrier by a microphone, digitizing the microphone and VS signals, and adaptive filtering the digitized VS signal, using the digitized microphone signal as a reference signal, to thus improve the quality of discerning. The apparatus includes a VS to sense vibrations of a barrier, a microphone located at the barrier internal side, analog to digital converters for digitizing the signals from the VS and microphone, respectively, and an adaptive filter receiving the vibration signal as a primary signal and the microphone signal as a reference signal, the adaptive filter comprising connected in series an adaptation algorithm unit, a linear filter and a subtractor.

### FIELD OF INVENTION

The invention provides a method and apparatus for enhancing discernability of a sound produced on one side of a barrier, to a listener located on its other side. To this end, a sound generated on one side of the barrier is reproduced on the other side thereof, whereas any sound generated on said other side of the barrier is suppressed. The barrier may be, for example, a wall, door, window, roof, etc. of a building, construction, or transportation device. Apparently, any such barrier more or less damps sounds reaching through (permeating) the barrier. In terms of this invention, the side where the listener is located shall be regarded as the internal side of the barrier, and the side where a sound to be discerned is produced, shall be regarded as the external side of the barrier.

### BACKGROUND

Discerning a sound reaching through a barrier may be needed in a variety of situations. One example may relate to a person inside a house, trying to discern external sounds, e.g. for safety reasons. Apparently, the sounds outside the house are damped by barriers such as walls, doors and windows. On the other hand, noises generated inside the house, such as family talks, sounds from radio/tv, etc. interfere with the damped external sounds and make their decerning even more difficult.

Further, discerning a sound reaching through a barrier can be helpful in various transport applications. For example, when a moving car is approached by a vehicle with a siren on, the soonest discerning the siren sound by the car driver is crucial for safety. Here, the car body, doors and windows are barriers damping external sounds including the siren. This damping may be significant because most car manufacturers explicitly design car bodies to be as soundproof as possible for the comfort of drivers and passengers. Moreover, internal sounds e.g. music reproduced by car audio, can interfere with discerning the siren by the car driver.

Another example relates to dashcams used to record video footage of the road and environment surrounding a vehicle during driving. In the event of an accident, dashcams are useful in evaluating driving behavior, understanding the circumstances of the accident, and determining fault or liability. A dashcam typically comprises a camera and a recorder all located inside the vehicle. Most modern dashcams include a built-in microphone. Sound picked by a microphone and recorded along with the video may add essential data such as the sounds of traffic or weather conditions, collisions, brake squeaks, etc. Recorded sounds can also provide information about the performance of the vehicle, such as the sounds of the engine or tires. This information can be useful in evaluating the condition of the vehicle and identifying potential safety concerns or maintenance issues.

Here again, external sounds are damped by the vehicle body, doors and windows and affected by internal sounds before reaching the microphone of the dashcam. This hinders the sound decerning when playing the record. Along with this, it is prohibited in many countries to record audio together with video even for security purposes, as it affects passengers' privacy. Removing the in-car sounds from the recording could alleviate this problem. What is said here regarding dashcams also relates to vehicle black boxes. In some jurisdictions, vehicle black boxes are required by law to record certain types of data, including sounds outside the vehicle. Recording sounds outside the vehicle can help ensure compliance with these regulations.

However, the invention is not limited to these examples, and relates to any situation in which a sound generated on one side (that shall be regarded as external side) of a barrier is to be perceived by a listener on the other (internal) side thereof.

### DESCRIPTION OF RELATED ART

The use of at least one microphone for picking up sound on the outside of a vehicle is widely known in the art, e.g from US20230065647 by Foster et al. Traditional microphones, however, are susceptible to harsh environmental conditions: rain, wind, hail, stones, oil, cleaning chemicals, high-pressure jet washers, etc. This problem is not addressed by Foster.

US20220227308 A1 by Wheeler et al. relates to a transducer receiving a vibration from a window or other vehicle surface and generating a signal associated with the vibration. The transducer is either attached to an internal portion of the rear-view mirror (FIG. 8B) or to an external side of automotive glass (FIG. 10). When attached to the rear-view mirror, the transducer acts as an internal microphone. When attached to an external side of automotive glass, the transducer acts as an external microphone. In both cases, however, the sounds inside the car can hinder discerning external sound. Further, the transducer disclosed by Wheeler is reported as “robust and weather resistant microphones that may be installed on vehicle exterior surfaces because they are generally unaffected by weather, dirt, etc”.

Thus, no microphone is described by Wheeler et al., which can pick sound produced on the exterior of the car, but does not need to be robust and weather resistant.

The use of car windows as an acoustic sensing device for external alarm signals is discussed by Bolzmacher et al. in their paper Transforming Car Glass into Microphones Using Piezoelectric Transducers: Microsyst Technol (2016) 22:1653-1663 DOI 10.1007/s00542-015-2795-x published 5 Jan. 2016. According to the paper, the glass panes of a Renault Zoé car have been equipped with piezoelectric sensors for picking up vibration signals. The output signals from the sensors were amplified and passed through a 100 Hz-4 kHz bandpass filter to remove low frequency noise due to vibrations emitted by the car. Tests have shown the efficiency of such a system able to detect siren signals. However, Bolzmacher et al. suggest nothing to make the siren better heard in the presence of noise or other internal sounds within the car compartment.

It can be seen that no means preventing internal sounds from interfering with external sounds perceivable inside the car are known in the art. The invention is aimed at enhancing discernability of a sound produced on one side of a barrier by a listener located on its other side. At the same time, the idea is to reach this goal by means of equipment that need not be weather resistant.

### SUMMARY

In one aspect the invention provides a method for enhancing discernability of a sound reaching through a barrier having an internal side and external side, the method including:
sensing vibrations of the barrier by means of a vibration sensor,
sensing the sound on the internal side of the barrier by means of a microphone,
digitizing the signals from the vibration sensor and microphone, respectively, and
adaptive filtering the digitized signal from the vibration sensor, using the digitized signal from the microphone as reference signal.

According to a preferred embodiment, vibrations of the barrier are sensed in the frequency range of the sound of interest acquired through the barrier. In transport applications this can be the sound of a siren that is limited by 4 KHz as discussed in Bolzmacher et al. The adaptive filtering can be performed in frequency sub-bands.

For simplicity, the microphone and vibration sensor signal can be equalized to have the same amplitude frequency response to sounds on the inner side of the barrier.

The signal equalization can be performed in the frequency sub-bands by introducing the corresponding equalization coefficients.

Preferably, to avoid cancellation of the external signal of interest, the adaptation of the filter in each sub-band is performed where the ratio of energies of the vibration and microphone signals in the corresponding sub-band is above a predetermined threshold.

Alternatively, prevention of cancellation of external sounds of interest can be achieved by limiting the amplitude frequency response of each sub-band filter to exceed a predetermined threshold.

In a further aspect the invention provides an apparatus for enhancing discernability of a sound reaching through a barrier having an internal side and external side, the apparatus including a vibration sensor configured to sense vibrations of a barrier, a microphone located at the internal side of the barrier, analog to digital converters (ADC) for digitizing the signals from the vibration sensor and microphone, respectively, and an adaptive filter that receives the vibration signal as the primary signal and the microphone signal as the reference signal, the adaptive filter comprising an adaptation algorithm unit, a linear filter, and a subtractor, all connected in series.

Because of the complexity of the optimization algorithms, almost all adaptive filters are digital filters. Therefore, the process of adaptive filtering, as well as other processes, methods, and algorithms described herein and/or depicted in the attached figures are preferably embodied in software modules executed by one or more physical computing systems, hardware computer processors and/or application-specific circuitry, configured to execute specific and particular computer instructions. For example, computing systems can include general purpose computers programmed with specific computer instructions or special purpose computers, special purpose circuitry, and so forth. A software module may be compiled and linked into an executable program, installed in a dynamic link library, or may be written in an interpreted programming language. In some implementations, particular operations and methods may be performed by circuitry that is specific to a given function.

Preferably the vibration sensor is attached to the barrier on the internal side thereof. This means that the vibration sensor, as well as the microphone, are inside a house or vehicle, so they do not have to be weather resistant.

The vibration sensor can be configured to sense vibrations in the frequency range of the sound reaching through the barrier.

According to a preferred embodiment, the vibration sensor can be attached to the barrier on the internal side thereof.

In transport applications, the barrier can be glass panel of a car window.

### BRIEF DESCRIPTION OF DRAWINGS

FIG. 1 schematically shows a configuration of vibration sensor and microphone of invention with respect to a barrier and sound sources.

FIG. 2 schematically illustrates the use of the invention for discerning a siren reaching through glass, wall or door of a car in which music is playing.

FIG. 3 is a block diagram illustrating the operation of adaptive filter.

FIG. 4 is a block diagram illustrating equalization of microphone signal frequency.

FIG. 5 is a block diagram illustrating sub-band adaptive filtering.

FIG. 6 is a block diagram illustrating equalization of microphone signal frequency in the sub-band scheme.

### DETAILED DESCRIPTION

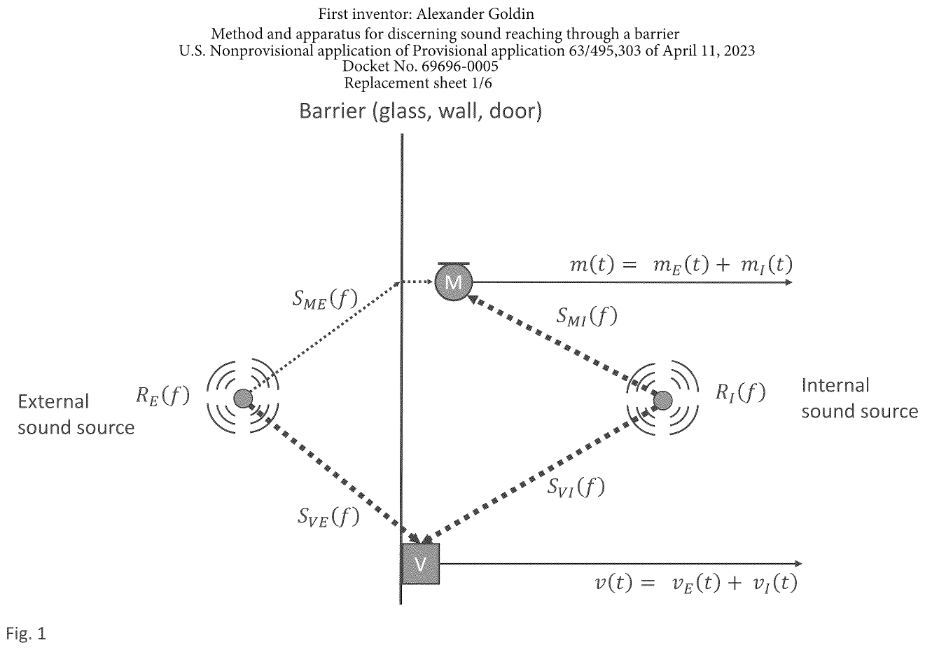

In FIG. 1, a barrier having an internal side and external side is schematically shown, where sound is produced by sound sources on the external side and internal side, respectively, of the barrier. According to the invention, sound on the internal side of the barrier is picked up by a microphone M, and vibration of the barrier is measured by a vibration sensor V.

The vibration sensor V is attached to the glass panel on its internal side. The vibration sensor V transforms vibrations of the barrier caused by outside and inside sounds into electrical signal v(t). Due to the linearity of the vibration sensor, the signal v(t) is the sum of two components:

$$v ( t ) = {v}_{E} ( t ) + {v}_{I} ( t )$$

where v_{E}(t) and v_{I}(t) correspond to vibrations caused by external and internal sounds, respectively.

The microphone M is located on the internal side of the barrier in close proximity of the vibration sensor V. More specifically, the distance between the microphone and the vibration sensor is less than half the wavelength of the maximal frequency in the working frequency range. For example, if the frequency range is limited by 4 KHz (maximal siren frequency or narrow band speech in telephony), the distance between the microphone and the sensor shall be less than 42 mm.

The microphone M transforms variations of inside sound pressure level into electrical signal m(t) which corresponds to sounds inside the car. Due to the linearity of the microphone, the signal m(t) is the sum of two components.

$$m ( t ) = {m}_{E} ( t ) + {m}_{I} ( t )$$

where m_{E}(t) and m_{I}(t) correspond to external and internal sounds, respectively.

The vibration sensor may be any vibration sensor with the operational frequency range covering the frequency range of the outside sound of interest, reaching through the barrier. For example, typical sirens are in the range of 500-4000 Hz including upper harmonics, so that for the reliable detection of sirens the bandwidth of 4 KHz is required. That roughly corresponds to the frequency range of consumer electronics vibration sensors used in some advanced headsets and earbuds to pick up user's voice by recording the vibration of the scull through bone conduction. Such sensors are manufactured today by several companies including ST Microelectronics, Sonion, Knowles, Infineon, Merry Electronics. Alternatively, due to less strict requirements on size and power consumption compared to consumer electronics chipsets designed for headsets and earbuds, a special sensor may be found or developed with better characteristics such as frequency range, signal to noise ratio, sensitivity, and self-noise.

The microphone may be any microphone suitable for the target application. For example, if the current invention is used for automotive applications to detect sirens or record other outside sounds, special, automotive grade microphones can be used.

The idea behind this invention is to extract the vibration signal component v_{E}(t) corresponding to external sound from the combined vibration signal v(t).

In case of a perfect barrier, the microphone is not sensitive to outside sounds, so that

$${m}_{E} ( t ) = 0 and m ( t ) = {m}_{I} ( t ) .$$

In practical situations the barrier is not perfect, and there is a leakage of outside sound into the microphone signal. The situation is illustrated in FIG. 1.

When the external sound source produces a sound wave with the frequency f and RMS sound pressure level R_{E}(f), it causes vibrations of the barrier with the same frequency that are picked up by the vibration sensor producing the electrical signal with RMS amplitude V_{E}(f). Sensitivity to the external sounds at the frequency f may be expressed as

$${S}_{VE} ( f ) = \frac{{V}_{E} ( f )}{{R}_{E} ( f )}$$

When the internal sound source produces a sound wave with the same frequency f and RMS sound pressure level R_{I}(f), it causes vibrations of the barrier with the same frequency that are picked up by the vibration sensor producing the electrical signal with amplitude V_{E}(f). Sensitivity to the external sounds at the frequency f may be expressed as

$${S}_{VI} ( f ) = \frac{{V}_{I} ( f )}{{R}_{I} ( f )}$$

Assuming that the barrier is symmetrical, the vibrations caused by the external and internal sounds of the same frequency with equal sound pressure levels shall be equal. In this case the two sensitivities shall be equivalent, so that

$${S}_{VE} ( f ) = {S}_{VI} ( f ) = {S}_{V} ( f )$$

The microphone and the vibration sensor are located in close proximity, and the microphone is located inside. Consequently, the sound pressure levels produced by internal sounds at the microphone location may be considered as equal to R_{I}(f).

The microphone produces an electrical signal of amplitude M_{I}(f) as a response to internal sound of frequency f with the RMS sound pressure level R_{I}(f) at the microphone location. The sensitivity of the microphone to internal sounds of frequency f is defined as

$${S}_{MI} ( f ) = \frac{{M}_{I} ( f )}{{R}_{I} ( f )}$$

An external sound of frequency f with RMS R_{E}(f) at the external side of the barrier is attenuated by the barrier before reaching the microphone located in the internal side by a factor of A_{EI}(f)<1. For example, in a car the attenuation of external sounds as measured inside and outside the car is in the range between 10 and 40 decibels depending on the car model and the frequency of the sound [2].

The sound pressure caused by an external sound of frequency f with RMS R_{E}(f) at the microphone internal location R_{EI}(f) is

$${R}_{EI} ( f ) = {A}_{EI} ( f ) \cdot {R}_{E} ( f )$$

Consequently, microphone sensitivity to external sounds can be written as

$${S}_{ME} ( f ) = \frac{{R}_{EI} ( f ) \cdot {S}_{MI} ( f )}{{R}_{E} ( f )} = \frac{( {A}_{EI} ( f ) \cdot {R}_{E} ( f ) ) \cdot {S}_{MI} ( f )}{{R}_{E} ( f )} = {A}_{EI} ( f ) \cdot {S}_{MI} ( f ) ≪ {S}_{MI} ( f )$$

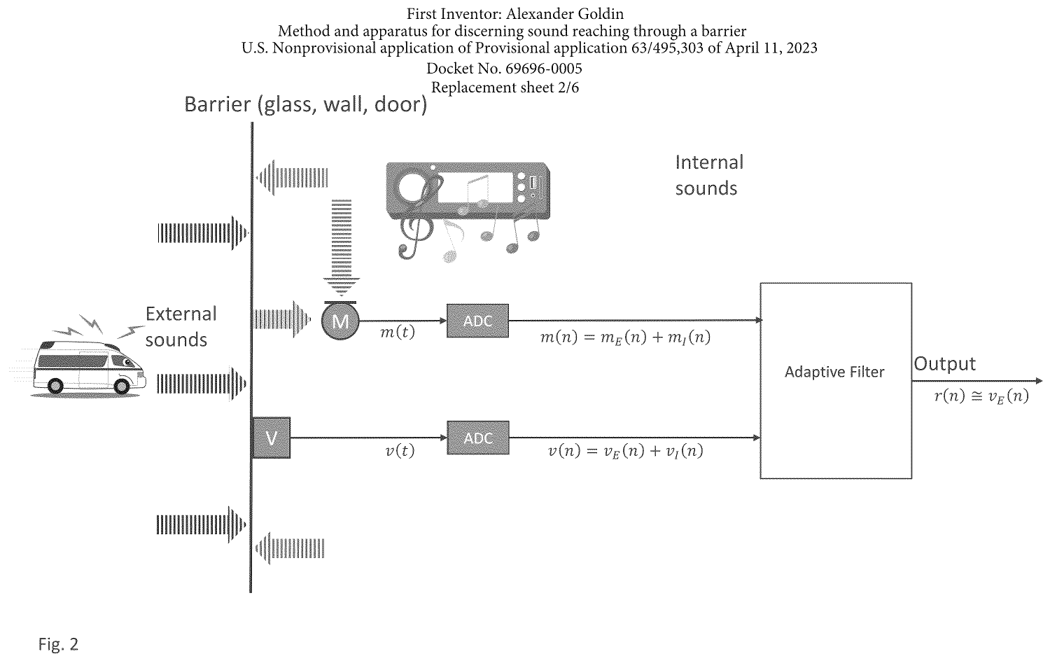

A practical example of the method and apparatus of the invention is presented in FIG. 2 schematically showing a vehicle with a siren on, wherein the sound of the siren meets a barrier, namely the glass panel of a car window. On the inner side of the barrier, in the car compartment, car audio is on, playing music. It can be seen in FIG. 2 that the sound on the internal side of the barrier is picked up by a microphone M, and vibration of the barrier is measured by a vibration sensor V in the similar manner as shown in FIG. 1, resulting in vibration sensor signal v(t) and microphone signal m(t).

The analog electrical signals v(t) and m(t) are digitized with the sampling rate F_{S} by respective analog to digital converters (ADC) producing the corresponding discrete time signals v(n) and m(n). Similar to analog signals, the discrete time vibration and microphone signals v(n) and m(n) are composed of two components corresponding to external and internal sounds.

$$v ( n ) = {v}_{E} ( n ) + {v}_{I} ( n )$$

$$m ( n ) = {m}_{E} ( n ) + {m}_{I} ( n )$$

The discrete time signals v(n) and m(n) are fed into the adaptive filter as primary and reference signals, respectively. As detailed below, the process in the adaptive filter results in signal where internal sound is eliminated or substantially attenuated. This signal may be fed to a siren recognition algorithm or a playback device (e.g. car audio), so that discernability of the external sound is enhanced.

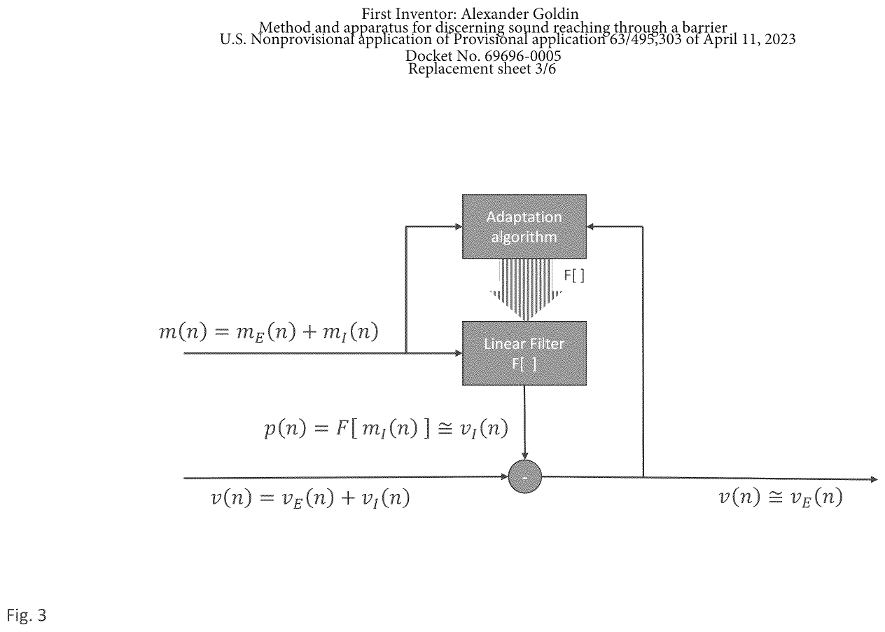

A typical structure of the adaptive filter is shown in FIG. 3. It consists of a linear filter, adaptation algorithm unit and the subtractor all connected in series.

The output of the linear filter is p(n) that is a prediction of the portion v_{I}(n) corresponding to internal sounds in the combined signal v(n)

$$p ( n ) = F \{ m ( n ) \} ≅ {v}_{I} ( n ) ,$$

where { } denotes the filtering operation. In the ideal case, after the subtraction, the output of the adaptive filter shall be the component v_{E}(n) of the vibration signal corresponding to external sounds only.

There are various types of linear filters such as Finite Impulse Response, Infinite Impulse Response as well as non-linear filters that can be used for predicting v_{I}(n). In the preferred embodiment, the Finite Impulse Response (FIR) linear filter is used.

The filtering operation by a Finate Impulse Response filter of the length L is defined as follows.

$$p ( n ) = F \{ m ( n ) \} = {\sum }_{i = 1}^{L} F ( i ) \cdot m ( n - i + 1 )$$

The length of the filter L corresponds to the duration of the vibration impulse response T_{V} of the barrier as L=T_{V}·F_{S}. T_{V} may depend on the material, size, shape as well as the position of the sensor. For the car windshield it is less than 30 milliseconds.

The coefficients of the linear filter are constantly updated by the adaptation algorithm according to principles of adaptive filtering specified in multiple books and scientific papers. For example, a good review of various adaptation strategies is given in [1]. While adaptation algorithms differ in many aspects such as the convergence rate, stability, and computational complexity, this is not relevant for the purpose of this invention.

In the preferred embodiment of the current invention, the adaptation algorithm is based on Normalized Least Mean Squares algorithm [1] which is simple and computationally efficient. The adaptation is continuous and given as

$$F ( n + 1 ) = F ( n ) + \frac{α \cdot r ( n ) \cdot M ( n )}{{‖ M ( n ) ‖}^{2}} ,$$

where r(n)=v(n)−p(n) is the residual filtration error at the iteration n which is the output of the adaptive filter, F(n) is a vector of L filter coefficients used in the iteration n, M(n) are the vector of L last microphone signal samples, M(n)=[m(n), m(n−1) . . . m(n−K+1)]^{T}, ∥M(n)∥² is the squared Euclidean norm of the vector M(n), and α is the adaptation speed that is chosen to provide a good tradeoff between the convergence speed and stability of the filter.

After the convergence, the result of the subtraction of the filtered microphone signal p_{I}(n) from the original, primary sensor signal v(n) minimizes the average energy of the output signal. For an ideal barrier, the microphone is not sensitive to sounds outside the barrier and M_{E}(n)=0. Since external and internal sound sources are not correlated, the microphone signal m(n)=m_{I}(n) and the vibration signal component generated by external sounds v_{E}(n) are not correlated. In this case the least mean squares minimization criteria is achieved when p(n)=v_{I}(n), so that the output of subtraction block r(n) corresponds to the vibration signal v_{E}(n) caused by the outside sounds only.

When the barrier is not perfect, the microphone signal part corresponding to external sounds is not zero m_{E}(n)≠0. In this case an unconstrained adaptive filtering may lead to cancellation of the signal of interest v_{E}(n). For example, when there is no internal sound m_{I}(n)=0, v_{I}(n)=0. In this case the reference and the primary signals to the adaptive filter m_{E}(n) and v_{E}(n) will be strongly correlated. If the linear filter coefficients are not constrained to prevent cancellation of v_{E}(n), then

$$p ( n ) = F \{ {m}_{E} ( n ) \} ≅ {v}_{E} ( n )$$

and the output of the adaptive filter
r(n)=v_{E}(n)−p(n) will contain no or significantly attenuated external signal of interest v_{E}(n).
Preventing attenuation of v_{E}(n) requires imposing constraints on the linear filter or on the adaptation process.

### Constrained Adaptive Filtering

According to preferable embodiment, adaptation may be limited to intervals where strong internal sounds are present, to prevent attenuation of v_{E}(n). Assuming the sensitivity and frequency responses of the microphone and vibration sensor to internal sounds are equalized, such intervals can be detected by calculating Q(n), the ratio of short time RMS levels of the microphone [symbol] m(n) [symbol] and the vibration sensor signals [symbol] v(n)

[symbol]

$$Q ( n ) = \frac{〈 m ( n ) 〉}{〈 v ( n ) 〉}$$

$$〈 m ( n ) 〉 = {( \frac{1}{K} {\sum }_{i = 1}^{K} {m ( n - i + 1 )}^{2} )}^{0.5}$$

$$〈 v ( n ) 〉 = {( \frac{1}{K} {\sum }_{i = 1}^{K} {v ( n - i + 1 )}^{2} )}^{0.5} ,$$

where K is the energy averaging interval of the discrete time signals.

Due to equalized sensitivity to internal sounds

$${Q}_{I} = \frac{〈 {m}_{I} ( n ) 〉}{〈 {v}_{I} ( n ) 〉} ≅ 1$$

Due to attenuation of external sounds by the barrier

$${Q}_{E} = \frac{〈 {m}_{E} ( n ) 〉}{〈 {v}_{E} ( n ) 〉} < < 1$$

Consequently, adaptation is enabled when there is a strong internal signal indicated by the condition

$$Q ( n ) > {Q}_{T} , {Q}_{E} < {Q}_{T} < 1 ,$$

where the threshold Q_{T} may need to be found experimentally for the best tradeoff cancelling internal sounds v_{I}(n) and preserving external ones v_{E}(n) in the vibration signal v(n).

Alternatively to the hard threshold, it is possible to control the speed of the filter adaptation α based on the current value Q(n). The speed of adaptation α shall be a monotonic, not decreasing function of Q(n) so that the larger Q(n) is, the faster is the adaptation of the filter coefficients.

Another way to ensure preservation of the external sound in the output e(n) is to limit the coefficients of the linear filter to prevent its amplitude frequency response to exceed some threshold.

Efficient cancellation of the vibration signal by subtracting a filtered version of the microphone signal requires

$$V ( f ) = \vert F ( f ) \vert \cdot M ( f ) or \\ \vert F ( f ) \vert = \frac{V ( f )}{M ( f )}$$

for the whole working frequency range where |F(f)| is the amplitude frequency response of the filter F at frequency f.

Assuming the sensitivity and frequency responses of the microphone and vibration sensor to internal sounds are equalized V_{I}(f)≅M_{I}(f), the linear filter amplitude frequency response cancelling vibration signal components corresponding to internal sounds shall be |F_{I}(f)|≅1. On the other hand, due to the barrier, sensitivity of the microphone to external sounds is much smaller than that of the sensor, V_{E}(f)>>M_{E}(f) and, correspondingly, cancelling it requires a linear filter with the frequency response |F_{E}(f)|>>1.

As such, limiting the linear filter amplitude frequency response by some threshold value Fₘₐₓ≅1 so that |F(f)|<Fₘₐₓ will lead to

$${P}_{I} ( f ) = \vert F ( f ) \vert \cdot {M}_{I} ( f ) ≅ {V}_{I} ( f ) \\ {P}_{E} ( f ) = \vert F ( f ) \vert \cdot {M}_{E} ( f ) < < {V}_{E} ( f ) ,$$

where P(f) is the amplitude of the signal frequency f in the linear filter output p(n).

Consequently, limiting the linear filter frequency response allows cancellation of vibration signal components caused by internal sounds v_{I}(n) while preventing cancellation of vibration signal components caused by external sounds v_{E}(n).

### Microphone Signal Equalization

Sensitivities of the microphone and the vibration sensor sensitivities to internal sounds can be equalized by passing the microphone signal m(n) via a digital equalization filter Z{ } with a fixed frequency response.

$${Z}_{I} ( f ) = \frac{{s}_{VI} ( f )}{{s}_{MI} ( f )} ,$$

where S_{VI}(f) and S_{MI}(f) are sensitivities of the sensor and the microphone to internal sounds respectively. S_{VI}(f) and S_{MI}(f) can be measured during a calibration procedure performed once. Following the filtering, the sensitivities become equal, so that

$${S}_{VI} ( f ) = {S}_{MI} ( f ) = {S}_{I} ( f )$$

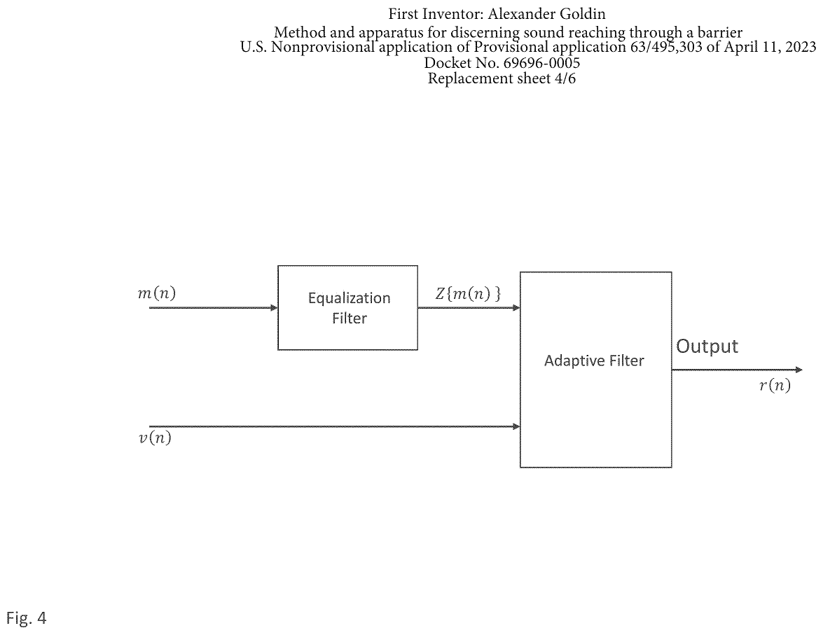

The equalization filter shall be placed before the adaptive filter as shown in FIG. 4.

### Sub-Band Adaptive Filtering

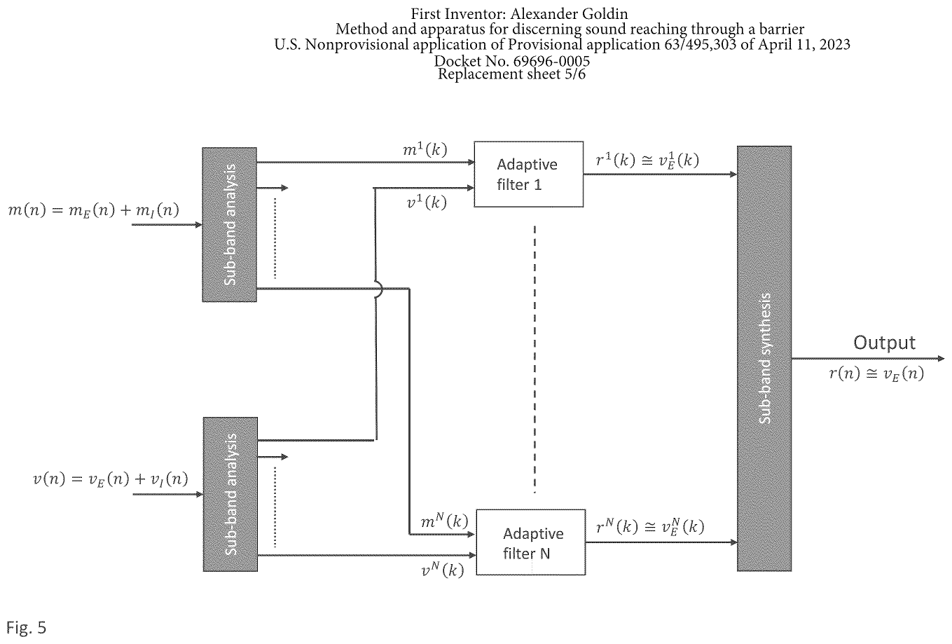

In the preferred embodiment of the current invention, sub-band adaptive filtering approach is used. FIG. 5 illustrates the concept. In both cases, the primary and reference signals are first divided into N uniformly distributed frequency sub-bands with central frequencies {f_{b}} as

$${f}_{b} = \frac{( b - 1 ) \cdot {F}_{S}}{2 \cdot ( N - 1 )} , b = 1 … N ,$$

each band corresponding to a narrow range of frequencies with a possible overlap between adjacent bands. Filter banks or Short Time Fourier Transform (STFT) approach may be used. In both cases, to reduce computational load, division into sub-bands is done together with downsampling by some integer factor D. The corresponding downsampled sub-band signals are m^{b}(k) and v^{b}(k) with the sampling rate F_{S}^{B}

$${F}_{S}^{B} = \frac{{F}_{S}}{D}$$

After that, the sub-band signals v^{b}(k) and m^{b}(k) are processed independently, each by its own Adaptive Filter. To cover the same time span as the full band adaptive filter, the length of the sub-band linear filters L^{B} is reduced accordingly.

$${L}^{B} = int ( \frac{L}{D} ) + 1 ,$$

where int(·) is the operation of taking the integer part of the division.
At the last stage, the resulting sub-band outputs e^{b}(k) of all filters are combined into the full band output signal according to the methods used for the sub-band decomposition. The output signal can be used for detecting certain events by a signal analysis software (for example, it can be siren detection, voice detection or any other sound of interest) or for reproducing the sound inside. For example, it can enable a sound transparency mode in a car or, when a certain event is detected, playing this sound louder (a siren can be played inside a car so that people with hearing loss can hear it).

Similar to the full band implementation for an ideal barrier, the microphone sub-band signals contain only sub-band components corresponding to inside sound m_{I}^{b}(k) that are not correlated with the sub-band vibration signals components v_{E}^{b}(k) caused by sounds outside the barrier. In this case the least mean squares minimization criteria in each sub-band is achieved when p^{b}(k)=v_{I}^{b}(k) so that the output of the sub-band subtraction block corresponds to the sub-band vibration signal v_{E}^{b}(k) caused by the outside sounds only.

In practical situations the barrier is not perfect and there is a leakage of outside sound into the microphone signal as illustrated in FIGS. 1 and 2.

If the microphone sub-band signal corresponding to external sounds is not zero m_{E}^{b}(k)≠0, unconstrained adaptive filtering may lead to cancellation of the signal of interest v_{E}^{b}(k). For example, when there is no internal sound m_{I}^{b}(k)=0, v_{I}^{b}(k)=0. In this case the reference and the primary sub-band signals to the adaptive filter m_{E}^{b}(k) and v_{E}^{b}(k) will be strongly correlated. If the sub-band linear filter coefficients F^{b} are not constrained to prevent cancellation of v_{E}^{b}(k), then

$${p}^{b} ( k ) = {F}^{b} \{ {m}_{E}^{b} ( k ) \} ≅ {v}_{E}^{b} ( k )$$

and the output of the adaptive filter in the sub-band b

$${r}^{b} ( k ) = {v}_{E}^{b} ( k ) - {p}^{b} ( k )$$

will contain no or significantly attenuated sub-band signal of interest v_{E}^{b}(k).

Preventing attenuation of each sub-band signal v_{E}^{b}(k) requires imposing constraints on the sub-band linear filters frequency responses or on the adaptation process.

Adaptation in each sub-band may be controlled globally for all sub-bands or separately for each sub-band. For example, it may be limited to intervals where strong sub-band signal components corresponding to internal sounds are present.

Similar to the full band implementation and assuming the sensitivity and frequency responses of the microphone and vibration sensor to internal sounds are equalized V_{I}(f)≅M_{I}(f), such intervals can be detected separately for each sub-band by calculating sub-band ratios Q^{b}(k) of short time RMS levels of the sub-band microphone [symbol] m^{b}(k) [symbol] and the sensor signals [symbol] v^{b}(k)

[symbol]

$${Q}^{b} ( k ) = \frac{〈 {m}^{b} ( k ) 〉}{〈 {v}^{b} ( k ) 〉} ,$$

where [symbol] . . . [symbol] denotes short time RMS value defined above for the full band case.

Adaptation of the sub-band linear filter F^{b} is enabled when

$${Q}^{b} ( k ) > {Q}_{T}^{b} , {Q}_{T}^{b} < 1 ,$$

where Q_{T}^{b} is a threshold ratio for the band b. Having different thresholds for different sub-bands provides more flexibility compared to one threshold for the full-band implementation.

Similar to the full-band case, preservation of the sub-band vibration signals of interest can also be done by limiting the frequency responses of the sub-band linear filters F^{b} by some threshold value Fₘₐₓ≅1 so that |F^{b}(f)|<Fₘₐₓ, b=1 . . . N will lead to

$${P}_{I}^{b} ( f ) = \vert {F}^{b} ( f ) \vert \cdot {M}_{I}^{b} ( f ) ≅ {V}_{I}^{b} ( f ) \\ {P}_{E}^{b} ( f ) = \vert {F}^{b} ( f ) \vert \cdot {M}_{E}^{b} ( f ) < < {V}_{E}^{b} ( f ) ,$$

where P^{b}(f) is the amplitude of the sub-band signal of frequency f in the sub-band linear filter output p^{b}(n).

Consequently, limiting the frequency responses of the sub-band linear filters allows cancellation of sub-band vibration signal components caused by internal sounds v_{I}^{b}(n) while preventing cancellation of vibration signal components caused by external sounds v_{E}^{b}(n).

### Microphone Frequency Equalization in the Sub-Band Scheme

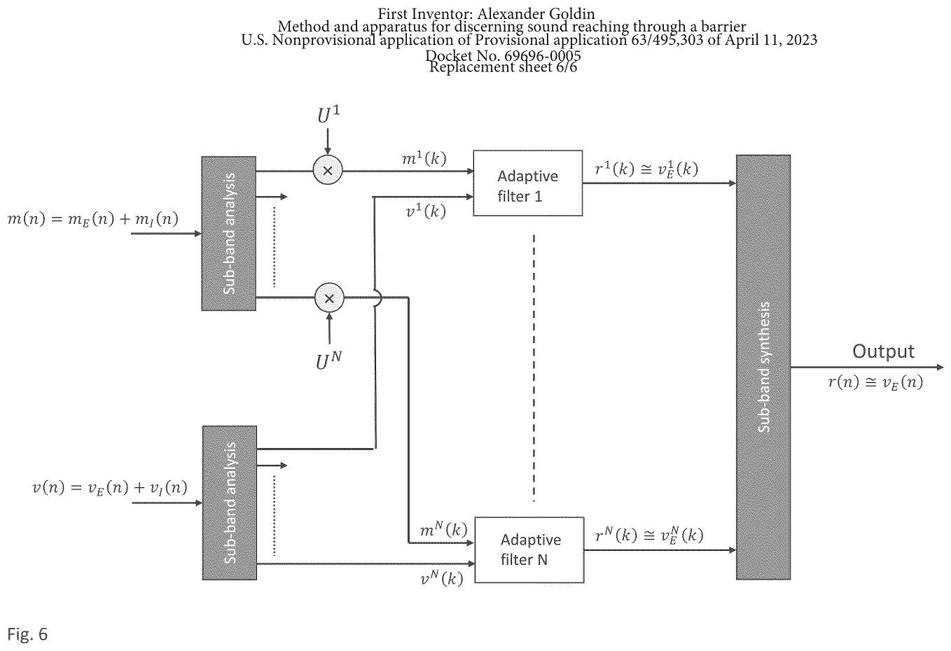

Microphone signal equalization to equal the microphone and vibration sensor sensitivities for internal sounds can be done similarly to the full band implementation by adding the equalization filter before the adaptive filter as shown in FIG. 4. Alternatively, it can be done inside the adaptive filtering scheme by multiplying every sub-band microphone signal m^{b}(k) by its sub-band sensitivities ratio Up as shown in FIG. 6.

$${U}_{b} = \frac{{S}_{V} ( {f}_{b} )}{{S}_{MI} ( {f}_{b} )}$$

### REFERENCES

1. Haykin Simon, Adaptive Filter Theory. Upper Saddle River, NJ: Prentice-Hall, Inc., 1996.
2. A. Balastegui et al, Applied Acoustics, 2013, New siren tones optimized for increased detectability distances of emergency vehicles.

1. A method for discerning sound reaching through a barrier having an internal side and an external side, the method including:
sensing vibrations of the barrier by means of a vibration sensor,
sensing the sound on the internal side of the barrier by means of a microphone,
digitizing signals from the vibration sensor and from the microphone, and
adaptive filtering the digitized signal from the vibration sensor, using the digitized signal from the microphone as a reference signal,
whereby the discernability of sound is enhanced.

2. The method of claim 1, wherein vibrations of the barrier are sensed in a frequency range of the sound reaching through the barrier.

3. The method of claim 1, wherein the microphone signal and the vibration sensor signal are equalized to have the same amplitude frequency response to sounds on the inner side of the barrier.

4. The method of claim 1, wherein the adaptive filtering is performed where the ratio of short time energies of the microphone signal and vibration signal, respectively, is above a predetermined threshold.

5. The method of claim 4, wherein the predetermined threshold is based on the attenuation of the barrier.

6. The method of claim 1, wherein coefficients for the adaptive filtering are limited to prevent amplitude frequency response thereof from exceeding a predetermined threshold.

7. The method of claim 1, wherein the adaptive filtering is performed in frequency sub-bands.

8. The method of claim 7, wherein the microphone signal and vibration sensor signal in each frequency sub-band are equalized to have the same amplitude frequency response to sounds on the inner side of the barrier for the corresponding sub-band.

9. The method of claim 7, wherein the adaptive filtering in each sub-band is performed where the ratio of short time energies of the microphone signal and vibration signal is above a predetermined threshold for the corresponding sub-band.

10. The method of claim 7, wherein coefficients for the adaptive filtering in each sub-band are limited to prevent amplitude frequency response thereof from exceeding a predetermined threshold for the corresponding sub-band.

11. An apparatus for discerning sound reaching through a barrier having an internal side and external side, the apparatus comprising a vibration sensor configured to sense vibrations of a barrier, a microphone located at the internal side of the barrier, analog to digital converters for digitizing the signals from the vibration sensor and microphone, respectively, and an adaptive filter that receives the vibration signal as a primary signal and the microphone signal as a reference signal, the adaptive filter comprising an adaptation algorithm unit, a linear filter and a subtractor, all connected in series, whereby discerning sound is enhanced.

12. The apparatus of claim 11, wherein the vibration sensor is configured to sense vibrations in the frequency range of the sound reaching through the barrier.

13. The apparatus of claim 11, wherein the vibration sensor is attached to the barrier on the internal side thereof.

14. The apparatus of claim 11, wherein the barrier is a glass panel of a car window.
